(19) United States
(12) Patent Application Publication
(10) Pub. No.: US 2026/0071668 A1
(43) Pub. Date: Mar. 12, 2026

(54) ROLLER SCREW DRIVE AND METHOD FOR ASSEMBLING A ROLLER SCREW DRIVE

(71) Applicant: Schaeffler Technologies AG & Co. KG, Herzogenaurach (DE)

(72) Inventor: Hans-Joachim TROESCH, Hermeskeil (DE)

(73) Assignee: Schaeffler Technologies AG & Co. KG, Herzogenaurach (DE)

(21) Appl. No.: 19/325,712

(22) Filed: Sep. 11, 2025

(30) Foreign Application Priority Data
Sep. 12, 2024 (DE) 102024126285.0

(51) Int. Cl. F16H 25/22; F16H 57/00

(52) U.S. Cl. CPC F16H 25/2252; F16H 2025/2276; F16H 2057/0056

(57) ABSTRACT

A roller screw drive, in particular in the form of a planetary roller gear, a roller screw drive or an inverse roller screw drive, including a threaded spindle with an external thread, a plurality of planets, and a spindle nut with an internal profile. Each planet has a profiled central section, which engages in the external thread of the spindle nut, and two equally profiled side sections which are thinner than the central section, which side sections each mesh with a section of the internal profile of the spindle nut. End sections of each planet adjoining the side sections are held in recesses of separate guide discs. Each recess for holding the planet has an assembly holding contour and an operating holding contour separated therefrom.

### CROSS-REFERENCE TO RELATED APPLICATIONS

This application claims priority from German Patent Application. No. 10 2024 126 285.0, filed Sep. 12, 2024, which is incorporated herein by reference as if fully set forth.

### TECHNICAL FIELD

The disclosure relates to a roller screw drive, suitable for use, for example, in an electromechanical actuator, in particular in the form of a planetary roller gear, a roller screw drive or an inverse roller screw drive. The disclosure further relates to a method for assembling a roller screw drive.

### BACKGROUND

A generic roller screw drive, namely a planetary roller gear, which is also generally referred to as a planetary roller screw drive, is known, for example, from DE 10 2011 075 950 B4. The known planetary roller gear has a plurality of elongated, groove-shaped profiled planets, which are received in guide rings at their respective ends. There can be two separate guide rings, which are not necessarily mirror images of each other. Furthermore, DE 10 2011 075 950 B4 describes an embodiment in which the guide rings are connected to one another by connecting pieces.

A planetary roller screw drive described in WO 2011/113724 A1 has planets that are mounted in centering discs. Each centering disc has a number of holes or slotted holes distributed around the circumference corresponding to the number of planets, into which the pins of the planets engage. A pretensioning device keeps the planets in effective engagement even when the planetary roller screw drive is unloaded, so that a relative rotation between the nut and the threaded spindle of the planetary roller screw drive is converted into an axial displacement between the aforementioned screw drive elements, i.e., the threaded spindle and the spindle nut, with very low slip.

A roller screw drive disclosed in DE 10 2021 202 539 A1, like the devices according to the documents DE 10 2011 075 950 B4 and WO 2011/113724 A1, comprises a plurality of rollers, i.e., planets, which have a pitchless profile, i.e., are provided with non-helical grooves. In the case of DE 10 2021 202 539 B4, a cage is configured to press a spindle of the roller screw drive into a radially centered position in a nut.

### SUMMARY

The disclosure is based on the object of further developing roller screw drives which—for example in the form of planetary roller gears—convert a rotation into a linear movement, compared to the prior art, in particular from a manufacturing point of view.

This object is achieved according to the disclosure by a roller screw drive in accordance with the present disclosure. In particular, the roller screw drive is a planetary roller gear. The object is also achieved by a method for assembling a roller screw drive in accordance with the present disclosure. As far as this text refers to a planetary roller gear, the corresponding statements can be transferred to other types of roller screw drives as long as no technical contradictions arise. Similarly, the designs and advantages of the disclosure explained in connection with the assembly method also apply mutatis mutandis to the device according to the application, i.e., the roller screw drive, and vice versa.

The planetary roller gear or other roller screw drive comprises, in a known basic concept, a threaded spindle with an external thread, a plurality of planets, and a spindle nut with an internal profile. Each planet, whose diameter is generally referred to as the roller diameter (Ro), has a profiled central section which engages with the external thread of the threaded spindle. In particular, the profile of the central section is groove-shaped, i.e., pitchless. In addition to the central section, i.e., the section having the diameter Ro, there are two side sections of the planet which are also profiled, in particular provided with grooves, i.e., which have no pitch and are thinner than the central section. Each of these side sections meshes with a section of the internal profile of the spindle nut. The end sections of each planet adjacent to the two side sections are held in recesses of separate guide discs.

Each recess formed in the guide disc for selectively holding the planet in different positions has an assembly holding contour and an operating holding contour separate therefrom.

The assembly holding contour loses its function after the assembly of the roller screw drive, in particular the planetary roller gear, is complete. The assembly holding contour is only used again in the event of disassembly. It has been shown that by creating an additional assembly holding contour, at a distance from the operating holding contour, in which the end section of the planet is located during normal operation of the planetary roller gear, a significant simplification and increase in reliability during assembly and, if necessary, disassembly can be achieved without requiring a significantly increased space requirement. The individual planets, which are generally referred to as rollers, can be moved from their assembly position, i.e., their position determined by the assembly holding contour, to their operating position, i.e., their position determined by the operating holding contour, by means of a purely radial displacement. It is not necessary to remove the planets from the guide discs to change between the assembly position and the operating position.

The method according to the application for assembling a planetary roller gear or other roller screw drive comprises the following steps:

### Provision

a. of two screw drive elements, namely a threaded spindle and a spindle nut, wherein one of the two screw drive elements is provided as the drive element and the other screw drive element is provided as the output element of the roller screw drive to be assembled,
b. of a plurality of elongated, profiled planets, which are intended for direct interaction with both screw drive elements, and
c. of two guide discs which are provided for guiding one end of each planet and have recesses, into which the end of a planet can be selectively received in an assembly position or in an operating position separated therefrom,
Formation of an assembly group of all planets and the two guide discs, wherein each planet is initially located in the assembly position,
Merging of said assembly group with one of the two screw drive elements, Displacement of each planet from their assembly position to the operating position, Completion of the roller screw drive by adding the second screw drive element.

There are therefore two different options for forming an assembly group that includes the planets and the guide discs, and then merging this assembly group with one of the two screw drive elements:

According to a first variant, the assembly holding contours are located radially outside the operating holding contours. The planets are first inserted into the recesses of the guide discs in such a way that all end sections of the planets are guided in the assembly holding contours, i.e., in the radially outermost position. This creates an assembly group into which the spindle can be inserted without any interfering edges and without screwing movements. The arrangement which, in addition to the planets and the guide discs, includes one of the two screw drive elements, in this case the threaded spindle, is called the component group to distinguish it from the previously stated assembly group, which does not yet comprise either of the two screw drive elements. In short: The so-called component group is created from the above-mentioned assembly group by adding one of the screw drive elements.

Once the component group is assembled, the planets are pushed inwards, bringing them into their operating position. The entire component group, now configured ready for operation, is then screwed into the second screw drive element, in this case the spindle nut, thus completing the planetary roller gear, apart from any seals and connecting or auxiliary elements, such as snap rings to secure the axial position of individual components. The planetary roller gear can also be completed by screwing the spindle nut onto the previously assembled component group.

In this variant of the planetary roller gear, in which the assembly holding contours are located radially outside the operating holding contours, i.e., the planets have to be pressed inwards during assembly, the center points of the planets held by the assembly holding contours describe an outer assembly circle whose diameter is specified as DP_1a. The center points of the planets held by the operating holding contours describe an inner end position circle with a diameter DP_2i. At the same time, a circular cylinder circumscribing the threaded spindle creates an interfering edge circle with a diameter DP_S. In this case, any contours that may be connected to the threaded spindle and that must be overcome when the aforementioned assembly group consisting of the planets and guide discs is merged with the threaded spindle must be attributed to the threaded spindle. The following relations apply:

$$DP\_S < ( DP\_ 1 a - Ro )$$

$$DP\_S > ( DP\_ 2 i - Ro )$$

If the planetary roller gear assembled in the manner described, which represents the first variant, is to be disassembled, the complete component group, which in this case represents a spindle-roller ring unit, must first be unscrewed from the spindle nut, which is also called the nut ring. The planets can then be moved outwards into their assembly position with little force. Finally, the threaded spindle can be removed from the assembly group, which includes the guide discs and the planets. Alternatively, it is possible to unscrew the threaded spindle from the mentioned assembly group while the planets are still in the operating position.

According to a second variant, the assembly holding contours are located radially inside the operating holding contours, relative to the center axis of the planetary roller gear. In this case, the pre-assembled assembly group is initially constructed to be as slim as possible, which means that a circle drawn through the center axes of all planets, which lies in a plane normal to the center axis of the entire assembly group and thus of the subsequent planetary roller gear, has the smallest possible diameter. The slim assembly group can be inserted into the spindle nut, without any interfering edges even in this case, without having to turn any of the components of the assembly group or the spindle nut. Once the intended axial position of the assembly group in relation to the spindle nut is reached, the planets are pushed outwards into their operating position. The threaded spindle can then be screwed into the assembly group to complete the planetary roller gear. In this case too, the planetary roller gear can be disassembled in the reverse order.

In the second variant of the planetary roller gear, the center points of the planets held by the assembly holding contours describe an inner assembly circle with a diameter DP_1i, whereas the center points of the planets held by the operating holding contours describe an outer end position circle with a diameter DP_2a. Furthermore, in the second variant, an interfering edge circle with a diameter DP_M is described by a circular cylinder inscribed in the spindle nut. Analogous to the definition of the interfering edge circle placed around the threaded spindle, in the case of the interfering edge circle specified by the spindle nut, interfering contours which are connected to the respective screw drive element, in this case the spindle nut, must also be taken into account, which means that no interfering contours are located within the interfering edge circle. The following relations apply:

$$( DP\_ 1 i + Ro ) < DP\_M$$

$$DP\_M < ( DP\_ 2 a + Ro )$$

In both variants described, the difference between the diameter of the assembly circle and the diameter of the end position circle given in the operational state of the planetary roller gear can, for example, correspond to at least 15% and at most 40% of the roller diameter of the planets. Likewise, in both variants, two locking positions can be formed by the assembly holding contour and the operating holding contour, which can be changed by overcoming at least small elastic restoring forces.

In modified variants, the device according to the application can, for example, be a roller screw drive in which each of the components threaded spindle, rollers and nut has a thread. It is also possible to design the roller screw drive as an inverse roller screw drive. In this case, the rollers of the screw drive are held in an axially fixed position relative to the threaded spindle.

### BRIEF DESCRIPTION OF THE DRAWINGS

Two exemplary embodiments of the disclosure are explained in more detail below with reference to a drawing. In the drawings:

FIG. 1 shows components to be assembled, namely two guide discs and an exemplary planet, of a roller screw drive designed as a planetary roller gear,

FIG. 2 shows a detail section of the arrangement according to FIG. 1 in an end-face view, with the planet locked in an assembly position,

FIG. 3 shows, in a representation analogous to FIG. 3, one of the two guide discs and the planet displaced into the operating position, i.e., shifted radially inwards,

FIGS. 4 and 5 show, in schematic side views, the planetary roller gear with the planet also visible in FIGS. 2 and 3 in assembly and operating position, respectively,

FIGS. 6 and 7 show geometric features of the planetary roller gear according to FIG. 1 in the assembly process, with the planet shown as an example in the assembly and operating positions, respectively,

FIG. 8 shows components, namely two guide discs and an exemplary planet, of a further roller screw drive designed as a planetary roller gear,

FIG. 9 shows a detail section of a guide disc of the planetary roller gear according to FIG. 8 in a perspective view,

FIG. 10, 11 show, in views analogous to FIGS. 4 and 5, the planetary roller gear according to FIG. 8 with the planet shown as an example in assembly and operating position, respectively,

FIGS. 12-14 show geometric features of the planetary roller gear according to FIG. 8 in the assembly process, wherein the planet shown in the figures is in a pre-assembly, assembly, and operating position, respectively.

### DETAILED DESCRIPTION

Unless otherwise stated, the following explanations relate to both exemplary embodiments. Parts that correspond to each other or have basically the same effect are denoted with the same reference signs in all the figures.

A roller screw drive, identified overall by the reference number 1, is designed as a planetary roller gear in both exemplary embodiments. The planetary roller gear 1 is suitable, for example, for use in an electromechanical actuator (not shown in detail). With regard to the basic structure and function of the planetary roller gear 1, reference is made to the prior art cited at the outset.

The planetary roller screw drive 1 comprises a threaded spindle 2 and a spindle nut 3, which is also referred to as a nut ring or simply as a nut. The nut 3 can function as the drive element of the roller screw drive 1, while the threaded spindle 2 can be used as a rotationally secured, movable output element. Conversely, it is also possible to drive the threaded spindle 2 rotationally and to use the nut 3 as a linearly adjustable output element of the roller screw drive 1.

Planets 4, which are generally referred to as rollers, are arranged between the threaded spindle 2 and the nut 3. The term screw drive elements 2, 3 is used collectively for the threaded spindle 2 and the spindle nut 3. The thread, i.e., the external thread, of the threaded spindle 2 is indicated with 5. The spindle nut 3 has a groove-shaped internal profile 6 in sections and can be constructed in several parts, wherein in particular individual nut parts can be clamped against one another in order to operate the roller screw drive 1 with pretension.

Each planet 4 has an elongated shape with a graduated diameter. Here, a central section 7 of the planet 4 represents its thickest section, which determines the diameter of the planet 4, referred to as the roller diameter Ro. The central section 7 is provided with a groove-shaped profile 8, which engages in the external thread 5 of the threaded spindle 2 during normal operation of the planetary roller gear.

Comparatively thin side sections 9 are located on both sides of the central section 7. The side sections 9 are each provided in a corresponding manner with a groove-shaped profile 10, which meshes with the internal profile 6 of the nut 3 during operation of the roller screw drive 1. In each of the exemplary embodiments shown in the figures, the roller screw drive 1 comprises six planets 4. Likewise, designs with a different number of planets 4, in particular with at least three and a maximum of twelve planets 4, are feasible.

In adaptation to the geometry of the external thread 5, at least individual profiles 8 of different planets 4 are offset relative to each other in the axial direction of the threaded spindle 2 and thus of the entire planetary roller gear 1. In particular, three different planets 4 can exist, wherein a first group of three planets 4 is installed in a first orientation and a second group of three planets 4, which is composed identically to the first group of three, is installed in the opposite orientation in the planetary roller gear 1.

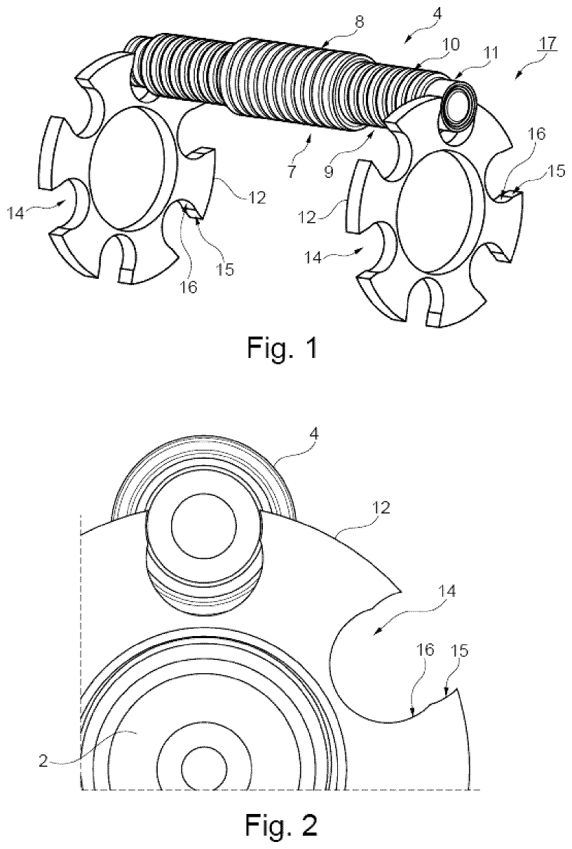

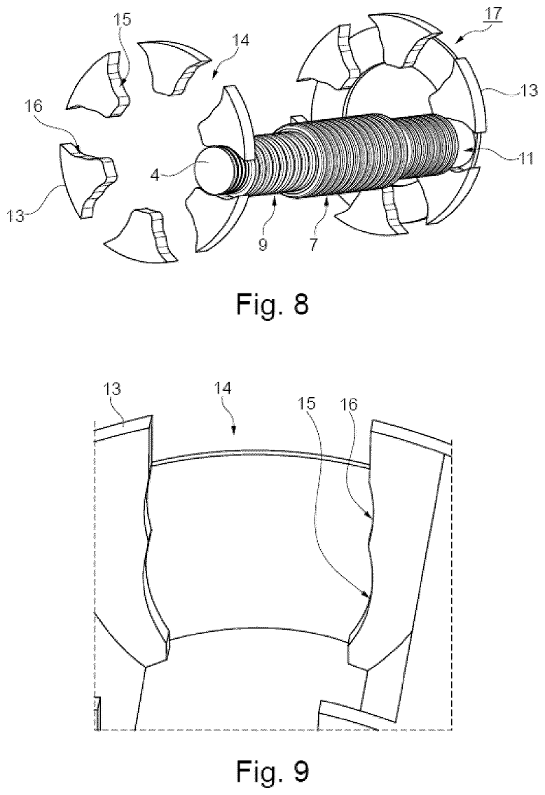

End sections 11 of each planet 4 are connected to the side sections 9. In contrast to the central section 7 and the side sections 9, the end sections 11 have a smooth cylindrical shape. Each end section 11 is held in a separate guide disc 12, 13. In the embodiment according to FIGS. 1 to 7, a pair of identical guide discs 12 are used, and in the embodiment according to FIGS. 8 to 13, a pair of identical guide discs 13 are used.

Each guide disc 12, 13 has a plurality of recesses 14 corresponding to the number of planets 4. The recess 14 is contoured such that the planet 4 can be held either in an assembly holding contour 15 or in an operating holding contour 16, which is spaced from the assembly holding contour 15 in the radial direction of the guide disc 12, 13 and thus of the entire planetary roller gear 1 to be assembled. In all constellations, i.e., as long as the planets 4 are in the assembly position, with the end sections 11 inserted into the assembly holding contours 15, as well as in the ready-to-operate configuration in which the end sections 11 are guided by the operating holding contours 16, i.e., have assumed their operating position, the center axes of all planets 4 are aligned parallel to the center axis of the pair of guide discs 12, 13. By overcoming a small elastic restoring force, changes between the assembly position and the operating position are possible. The assembly holding contours 15 and the operating holding contours 16 thus represent locking contours.

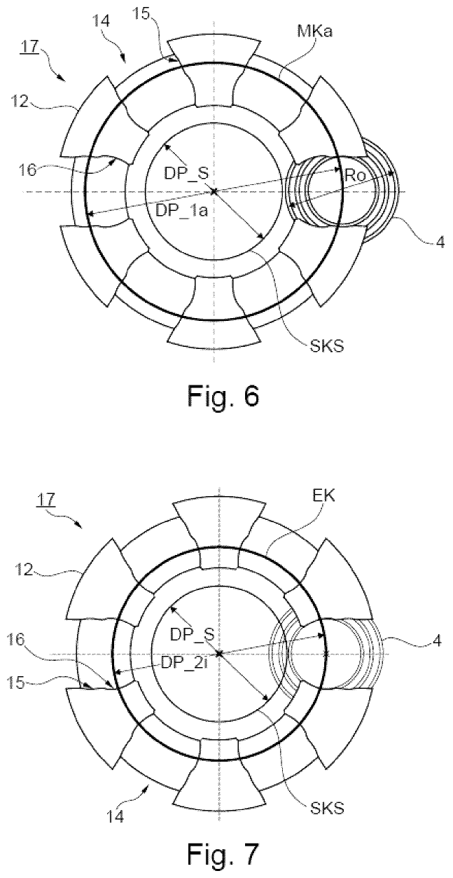

In the embodiment according to FIGS. 1 to 7, the assembly holding contours 15 are located radially outside the operating holding contours 16. This means that, for assembly purposes, as illustrated in FIGS. 1, 2, 4 and 6, the planets 4 are initially engaged so far outward into the recesses 14 of the guide discs 12 that operation of the roller screw drive 1 would not yet be possible. An outer assembly circle MKa, which is drawn in FIG. 6 and passes through the center points of all planets 4, has a diameter DP_1a. The arrangement of all planets 4 and both guide discs 12 is referred to as assembly group 17. After the assembly group 17, as can be seen in sections in FIGS. 1, 2, 4 and 6, has been assembled, the threaded spindle 2 can be easily inserted into this assembly group 17. In this case, an interfering edge circle SKS must be taken into account, which circumscribes the threaded spindle 2, in particular its external thread 6, including any further contours connected to the threaded spindle 2 that must be overcome during assembly. The diameter of the interfering edge circle SKS is specified as DP_S.

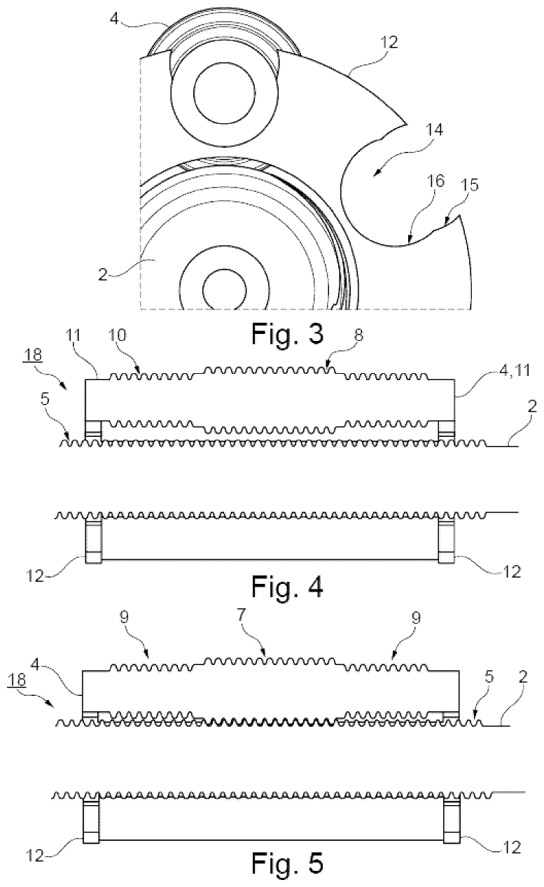

The arrangement of assembly group 17 and threaded spindle 2 is referred to as component group 18. Starting from the shape of the component group 18 outlined in FIG. 4, with the planets 4 provisionally fixed in the assembly holding contours 15, the planets 4 are pressed radially inwards, which results in the constellation of the component group 18 illustrated in FIGS. 3, 5 and 7, with the planets 4 finally guided in the operating holding contours 16. In this operational state, the center points of the planets 4 describe an end position circle EK, the diameter of which is specified as DP_2i.

In the exemplary embodiment according to FIGS. 1 to 7, in which the planets 4 are to be pushed from the outside to the inside when changing from the assembly to the operating position, the following relations apply:

$$DP\_S < ( DP\_ 1 a - Ro )$$

$$DP\_S > ( DP\_ 2 i - Ro )$$

The exemplary embodiment according to FIGS. 8 to 14 differs from the exemplary embodiment according to FIGS. 1 to 7 in that the planets 4 have to be pressed from the inside to the outside during assembly. Accordingly, the assembly holding contours 15 are located radially inside the operating holding contours 16.

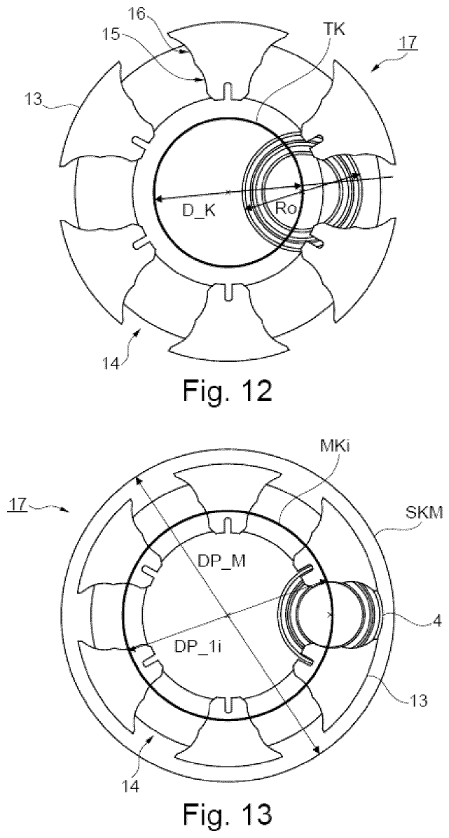

The assembly group 17 formed from the planets 4 and the guide discs 13 initially has the constellation shown in FIG. 12, which is referred to as the pre-assembly constellation. Here, the planets 4 are tangential to the contours of the guide disc 13 from the inside. A circle passing through the center points of the planets 4 and labeled as TK has a diameter D_k. Starting from the pre-assembly position of the planets 4, they are brought into the assembly position, which can be seen in FIGS. 8, 10 and 13, by overcoming moderate elastic restoring forces. The planets 4 are thus locked into the assembly holding contours 15. It is also possible to successively move the individual planets 4 from the respective pre-assembly position to the assembly position.

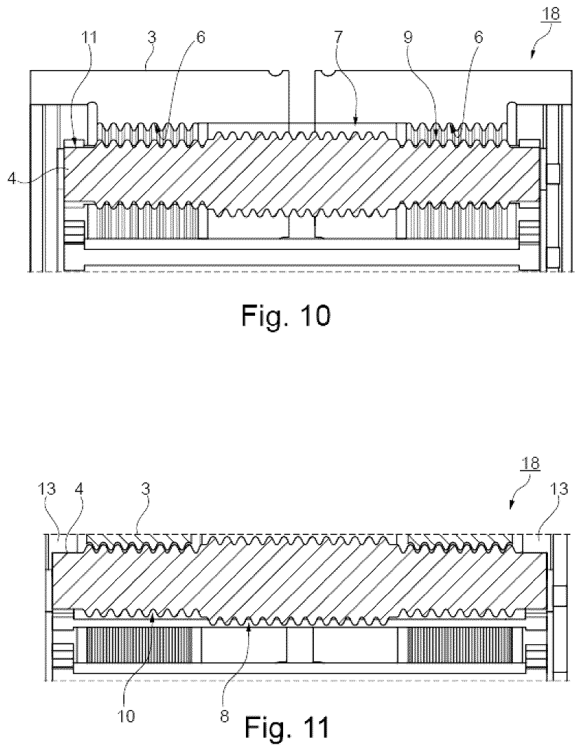

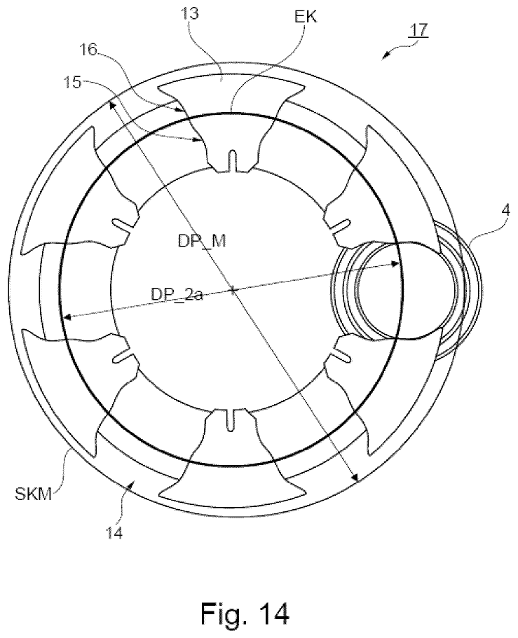

In the next step, the assembly group 17 formed from the planets 4 and the two guide discs 13 is assembled with the spindle nut 3 to form a component group 18, as shown in FIG. 10. The planets 4 initially remain in the assembly position shown in FIG. 13 using a single planet 4 as an example. An inner assembly circle Mki, which is drawn in FIG. 13 and passes through the center points of all planets 4, has a diameter DP_1i.

Furthermore, an interfering edge circle SKM is shown in FIG. 13, which is formed by contours of the spindle nut 3 and any contours of other parts connected to it that may be tangential during assembly, and has a diameter DP_M. As can be seen from FIG. 13, the planets 4 are located within the interfering edge circle SKM, so that the assembly group 17 can be inserted into the spindle nut 3 by a purely linear movement.

After the assembly group 17 has been positioned relative to the spindle nut 3 in the intended manner, the planets 4 are moved from the inside to the outside into their operating position, overcoming moderate restoring forces, resulting in the arrangement according to FIGS. 11 and 14.

In the exemplary embodiment shown in FIGS. 8 to 14, the following relations apply:

$$( DP\_ 1 i + Ro ) < DP\_M$$

$$DP\_M < ( DP\_ 2 a + Ro ) ,$$

where, in this case too, Ro denotes the diameter of the planets 4. The diameter of the end position circle EK is indicated as DP_2a in the exemplary embodiment according to FIGS. 8 to 14, in which the planets 4 are displaced outwards during assembly.

### LIST OF REFERENCE SIGNS

1 Roller screw drive, planetary roller gear
2 Threaded spindle
3 Spindle nut
4 Planet, roller
5 External thread
6 Internal profile
7 Central section
8 Profiling of the central section
9 Side section
Profiling of the side section
11 End section
12 Guide disc, first exemplary embodiment (FIGS. 1 to 7)
13 Guide disc, second exemplary embodiment (FIGS. 8 to 14)
14 Recess
15 Assembly holding contour
16 Operating holding contour
17 Assembly group of planet 4 and guide discs 12, 13
18 Component group
D_k Diameter of the circle TK
DP_1a Diameter of the outer assembly circle
DP_1i Diameter of the inner assembly circle
DP_2i Diameter of the end position circle, with radially inwardly displaced planets
DP_2i Diameter of the end position circle, with radially outwardly displaced planets
DP_M Diameter of the interfering edge circle of the spindle nut
DP_S Diameter of the interfering edge circle of the threaded spindle
EK End position circle
MKa Outer assembly circle
MKi Inner assembly circle
Ro Roller diameter
SKM Interfering edge circle of the spindle nut
SKS Interfering edge circle of the threaded spindle
TK Circle with tangential contact of the planets on the guide disc

1. A roller screw drive comprising:
a threaded spindle with an external thread;
a plurality of planets; and
a spindle nut with an internal profile;
wherein each planet has a profiled central section defining a roller diameter (Ro) of the planet, which central section engages in the external thread of the spindle nut and two equally profiled side sections which are thinner than the central section, which side sections each mesh with a section of the internal profile of the spindle nut, and end sections of each planet adjoining the side sections are held in recesses of separate guide discs; and
wherein each recess for holding the planet has an assembly holding contour and an operating holding contour separated therefrom.

2. The roller screw drive according to claim 1, wherein the assembly holding contours are located radially outside the operating holding contours.

3. The roller screw drive according to claim 2, wherein center points of the planets held by the assembly holding contours describe an outer assembly circle (MKa) with a diameter (DP_1a), the center points of the planets held by the operating holding contours describe an inner end position circle (EK) with a diameter (DP_2i), and an interfering edge circle (SKS) with a diameter (DP_S) is described by a circular cylinder circumscribing the threaded spindle, wherein the following relations apply:
$$DP\_S < ( DP\_ 1 a - Ro )$$
$$DP\_S > ( DP\_ 2 i - Ro ) .$$

4. The roller screw drive according to claim 1, wherein the assembly holding contours are located radially inside the operating holding contours.

5. The roller screw drive according to claim 4, wherein center points of the planets held by the assembly holding contours describe an inner assembly circle (MKi) with a diameter (DP_1i), the center points of the planets held by the operating holding contours describe an outer end position circle (EK) with a diameter (DP_2a), and an interfering edge circle (SKM) with a diameter (DP_M) is described by a circular cylinder inscribed in the spindle nut, wherein the following relations apply:
$$( DP\_ 1 i + Ro ) < DP\_M$$
$$DP\_M < ( DP\_ 2 a + Ro ) .$$

6. The roller screw drive according to claim 5, wherein a difference between the diameter (DP_1a, DP_1i) of the assembly circle (MKa, MKi) and the diameter (DP_2a, DP_2i) of the end position circle (EK) corresponds to at least 15% and at most 40% of the roller diameter (Ro).

7. The roller screw drive according to claim 1, wherein two locking positions are formed by the assembly holding contour and the operating holding contour, which can be changed by overcoming at least small elastic restoring forces.

8. A method for assembling a roller screw drive comprising:
providing two screw drive elements, the screw drive elements including a threaded spindle and a spindle nut, a plurality of elongated, profiled planets which are provided for direct interaction with the screw drive elements, and two guide discs which are provided for guiding one end of each planet and have recesses, into which the end of a planet can be optionally received in an assembly position or in an operating position,
forming an assembly group of all planets and the two guide discs, wherein each planet is located in the assembly position;
merging of said assembly group with one of the two screw drive elements;
displacing each planet from the assembly position to the operating position; and
adding the other of the two screw drive elements to complete the roller screw drive.

9. The method according to claim 8, wherein the assembly group formed from the planets and the two guide discs is first merged with the threaded spindle.

10. The method according to claim 8, wherein the assembly group formed from the planets and the two guide discs is first merged with the spindle nut.

11. The method according to claim 8, wherein each planet has a profiled central section defining a roller diameter (Ro) of the planet, which central section engages in an external thread of the spindle nut and two equally profiled side sections which are thinner than the central section, which side sections each mesh with a section of an internal profile of the spindle nut, and end sections of each planet adjoining the side sections are held in recesses of separate guide discs; and
wherein each recess for holding the planet has an assembly holding contour and an operating holding contour separated therefrom.

12. The method according to claim 11, wherein the assembly holding contours are located radially outside the operating holding contours.

13. The method according to claim 12, wherein center points of the planets held by the assembly holding contours describe an outer assembly circle (MKa) with a diameter (DP_1a), the center points of the planets held by the operating holding contours describe an inner end position circle (EK) with a diameter (DP_2i), and an interfering edge circle (SKS) with a diameter (DP_S) is described by a circular cylinder circumscribing the threaded spindle, wherein the following relations apply:
$$DP\_S < ( DP\_ 1 a - Ro )$$
$$DP\_S > ( DP\_ 2 i - Ro ) .$$

14. The method according to claim 11, wherein the assembly holding contours are located radially inside the operating holding contours.

15. The method according to claim 13, wherein center points of the planets held by the assembly holding contours describe an inner assembly circle (MKi) with a diameter (DP_1i), the center points of the planets held by the operating holding contours describe an outer end position circle (EK) with a diameter (DP_2a), and an interfering edge circle (SKM) with a diameter (DP_M) is described by a circular cylinder inscribed in the spindle nut, wherein the following relations apply:
$$( DP\_ 1 i + Ro ) < DP\_M$$
$$DP\_M < ( DP\_ 2 a + Ro ) .$$

16. The method according to claim 15, wherein a difference between the diameter (DP_1a, DP_1i) of the assembly circle (MKa, MKi) and the diameter (DP_2a, DP_2i) of the end position circle (EK) corresponds to at least 15% and at most 40% of the roller diameter (Ro).

17. The method according to claim 11, wherein two locking positions are formed by the assembly holding contour and the operating holding contour, which can be changed by overcoming at least small elastic restoring forces.
